(19) United States
(12) Patent Application Publication
(10) Pub. No.: US 2026/0319158 A1
(43) Pub. Date: Oct. 15, 2026

(54) BOOM ARM FOR A BOOM GATE

(71) Applicant: Magnetic Autocontrol GmbH, Schopfheim (DE)

(72) Inventors: Thomas BÜRGIN, Lörrach (DE); Cvjetko TRIVUNOVIC, Weil am Rhein (DE); Bianca GERSBACHER, Schopfheim (DE); Tobias ORTLIEB, Aitern (DE); Dominik EGGERT, Zürich (CH); Emma EHRENBERG, Bad Neustadt an der Saale (DE); Martin HOFMANN, Schönenberg (CH); Daniel IRÁNYI, Steinhausen (CH); Arno LENZI, Adliswil (CH); Miriam NIETLISPACH, Aarau (CH); Reto SCHNELLER, Flims (CH); Stephanie THOMMEN, Rheinfelden (CH); Thibaut WENGER, Wichtrach (CH)

(73) Assignee: Magnetic Autocontrol GmbH, Schopfheim (DE)

(21) Appl. No.: 19/478,884

(22) PCT Filed: Apr. 25, 2024
(86) PCT No.: PCT/EP2024/061458

§ 371 Date: Oct. 27, 2025

(30) Foreign Application Priority Data
May 3, 2023 (DE) 20 2023 102 393.2

(51) Int. Cl. F21V 8/00; E06B 11/02; F21V 33/00

(52) U.S. Cl. CPC G02B 6/0036; E06B 11/022; F21V 33/00

(57) ABSTRACT

A boom arm (1) for a boom gate, in particular for the passage control of vehicles, having an arm profile (2), which forms an essential part of the boom arm (1), and having a light-emitting strip (13), which is attached over at least a part of the length of the arm profile (2) on its lower side and emits visible light into the surroundings of the boom arm (1) and which emits light over its entire length or at multiple points distributed over its length. The light-emitting strip (13) is combined with a light guide (8), into which it radiates the light, the light guide (8) is fastened to the arm profile (2) from below, and a carrier rail (6) for add-on parts is provided below the light guide (8), which is attached to the light guide (8) and/or to the arm profile (2).

### CROSS-REFERENCE TO RELATED APPLICATIONS

This application is a 371 National Phase of International Patent Application No. PCT/EP2024/061458, filed Apr. 25, 2024, which claims priority from German Patent Application No. 10 2023 102 393.2, filed May 3, 2023, both of which are incorporate herein by reference as if fully set forth.

### TECHNICAL FIELD

The invention relates to a boom arm for a boom gate, in particular for the passage control of vehicles.

### BACKGROUND

Such a boom arm is accordingly essentially formed by an arm profile, which is manufactured from a metallic material, for example, an aluminum extruded profile, or also a plastic or plastic composite material and normally is a hollow profile having grooves, rails, and undercuts for add-on parts provided as needed. The arm profile forms, with covers, films, paint, or the like and also, depending on the application, provided with a hinge, the essential part of the boom arm.

A light-emitting strip, in particular an LED strip, is attached in a boom arm of the present type over at least a part of the length of the arm profile on its lower side in order to emit visible light into the surroundings of the boom arm. The light-emitting strip can emit light over its entire length in this case, or also at multiple points distributed over its length, wherein the light sources distributed over its length are preferably arranged equidistantly.

Above all in the case of boom gates for the passage control of vehicles, as are typical in managed parking areas, parking garages, tollbooths, or areas only accessible to authorized users, boom arms which are illuminated by means of one or more light-emitting strips have been known for some time. The illumination is not only used for better recognizability of the closed boom at night and in poor light conditions, but can also emit optical signals by way of color changes, flashing characters, and the like and therefore deliver information to the surroundings, in particular vehicle drivers, operating personnel, and/or security personnel.

It is problematic in this case that the light emitted from the light-emitting strip can cause blinding, as is often the case when the light-emitting strip is attached to the lateral surfaces of the arm profile, so that vehicle drivers look directly at the light source. One example of an arm profile having laterally emitted light is disclosed in KR 20130012677 A. Such an example is also found in WO 2017/201212 A1.

To make the light signal visible on both sides of a boom arm, without having to also attach two light-emitting strips, CN 205742012 U proposed attaching the light-emitting strip to the upper side of the arm profile, so that its light can also be perceived on the front side and on the rear side of the boom gate. However, there is the problem here if multiple boom gates are arranged adjacent to one another that confusion can occur, for example, if an open boom arm lights up green in order to indicate a free passage.

Therefore, boom arms were proposed in CN 217419422 U and in WO 2021/240561 A1, in which a light-emitting strip is attached to the lower side of the arm profile. An edge protector arranged underneath, for example, made of silicone, is made translucent, and is used as a diffuser for the light emitted by the strip, so that it is perceptible on both sides of the boom arm. However, it is then no longer possible to attach add-on parts, such as a gate grid or pendulum supports, on the lower side of the arm profile.

### SUMMARY

The present invention is therefore based on the object of improving a boom arm of the type mentioned at the outset, which is equipped with a light-emitting strip on the lower side of its arm profile, with respect to the possibility of attaching add-on parts to the arm profile.

This object is achieved by a boom arm having one or more of the features disclosed herein. Preferred designs and refinements of the boom arm according to the invention are described below and in the claims.

A boom arm of the present type, having an arm profile which forms the essential part of the boom arm and is equipped with a light-emitting strip on its lower side, which extends over at least a part of the length of the arm profile and emits light over its entire length or at multiple points distributed over its length, is thus refined according to the invention such that the light-emitting strip is combined with a light guide, into which it emits the light, that the light guide is fastened to the arm profile from below, and that a carrier rail for add-on parts is provided below the light guide, which is attached to the light guide and/or to the arm profile.

The light guide used according to the invention, which can conduct the light from the light-emitting strip to an outer side of the arm profile, enables a carrier rail to be attached below the light-emitting strip, which does not have to be translucent and therefore in particular can consist of a metallic material. The light guide can in particular conduct the light from the light-emitting strip outward between the arm profile and the carrier rail, so that it is visible from the outside at the lateral surface of the arm profile, even if the carrier rail covers the light guide on the bottom.

The carrier rail enables greatly varying add-on parts, in particular a gate grating or hinged supports, or also a soft-elastic edge protector, which are regularly to be attached to the lower side of the arm profile, to be fastened to the boom arm.

Arm profiles of a boom arm of the present type are often provided on the lower side with at least one mounting groove in order to be able to attach the above-mentioned add-on parts. In this case, it is expedient if the light-emitting strip is seated in such a mounting groove on the lower side of the arm profile. Preferably, the strip is simply pushed into the mounting groove during the mounting.

The light guide present according to the invention, into which the light-emitting strip couples the light, is preferably likewise inserted in a formfitting manner into the arm profile or placed thereon, for example, in that undercuts of the profile or undercut grooves are engaged from behind by corresponding rail-shaped recesses of the light guide. A correspondingly shaped light guide is preferably also inserted longitudinally into the arm profile.

In a corresponding manner, it is preferred if the carrier rail is also seated in a formfitting manner on the light guide and/or on the arm profile. It is particularly preferred if the light guide has a profile having undercuts and the carrier rail is inserted in a formfitting manner into these undercuts of the light guide, in particular is simply pushed in.

It is expedient if the carrier rail can alternately be inserted or pushed in a formfitting manner onto the light guide or in a formfitting manner into the arm profile. In this way, a boom arm with illumination and a boom arm without illumination can be assembled from identical parts.

Special advantages result in the scope of the present invention if the carrier rail has on the lower side a mounting groove formed essentially identically to the arm profile (if it is provided with such a groove). For an add-on part, it then makes no difference whether the boom arm is provided with illumination, thus according to the invention with a light-emitting strip, a light guide, and the carrier rail, or not.

If the carrier rail is provided with essentially the same profile as the lower side of the arm profile, a completely unchanged lower side of the boom arm even results, whether or not it is equipped with illumination. In particular with this refinement of the present invention, an attachment option for a light-emitting strip on the lower side of the boom arm thus results, which leaves the externally accessible profile of the lower side of the boom arm unchanged in the final effect.

Further advantages result in the scope of the present invention if the carrier rail covers the light guide on the bottom, specifically such that the light guide only forms an externally visible light exit surface laterally on the boom arm, preferably on both sides of the boom arm. Such light exit surfaces that can be reduced to comparatively thin lines prevent blinding, which otherwise unavoidably has to be accepted if a light-emitting strip on the lower side of the arm profile is to be recognizable from both sides of the boom arm.

Using this preferred refinement of the present invention, illumination of the boom arm for the purpose of better recognizability and/or signaling can thus be achieved, which is recognizable on both sides of the boom arm, from the front side and from the rear side of the boom gate, without having to provide two light-emitting strips, without attaching the light signal to the upper side of the boom arm, where it can be misinterpreted in the case of open booms and multiple adjacent boom gates, and without having to accept a blinding effect on the lower side of the boom arm or having to dispense with add-on parts such as a gate grating or hinged supports.

Expediently, the light exit surface is or the two light exit surfaces of the light guide are each provided with a matte surface for light scattering, which is known to decisively improve the visibility from different observation angles. The light exit surfaces can also be provided with prismatic depressions extending along the arm profile for the same purpose.

If the light signal or the illumination is to be visible on both sides of the boom arm, it is preferred in the scope of the present invention to fasten the light-emitting strip approximately in the middle on the lower side of the arm profile and to provide a prismatic boundary surface for deflecting the light to both sides of the boom arm in the light guide, below the light-emitting strip.

The light guide can finally be shaped essentially V-shaped in its profile in order to conduct the light upward by means of the V legs, so that the light exit surfaces are arranged at the height of or ultimately even above the light-emitting strip. The light exit surfaces are then furthermore arranged in the lower area of the boom arm sides, but there is no light exit toward the lower side of the boom arm, so that any blinding or misinterpretation is precluded here; the light signal is then exclusively to be seen when the boom arm is approached from the front side or from the rear side.

### BRIEF DESCRIPTION OF THE DRAWINGS

An exemplary embodiment of a boom arm designed according to the invention will be described and explained in more detail hereinafter on the basis of the appended drawings. This is solely an example, which is not to be understood as restrictive for the invention; nonetheless, features essential to the invention can be included in the following description.

In the figures:

FIG. 1 shows a schematic view of a boom gate having a boom arm designed according to the invention;

FIG. 2 shows the profile of a boom arm from FIG. 1, but in a design according to the prior art;

FIG. 3 shows the profile of a boom arm designed according to the invention;

FIG. 4 shows a partial section from FIG. 3;

FIG. 5 shows the indicated detail from FIG. 3.

### DETAILED DESCRIPTION

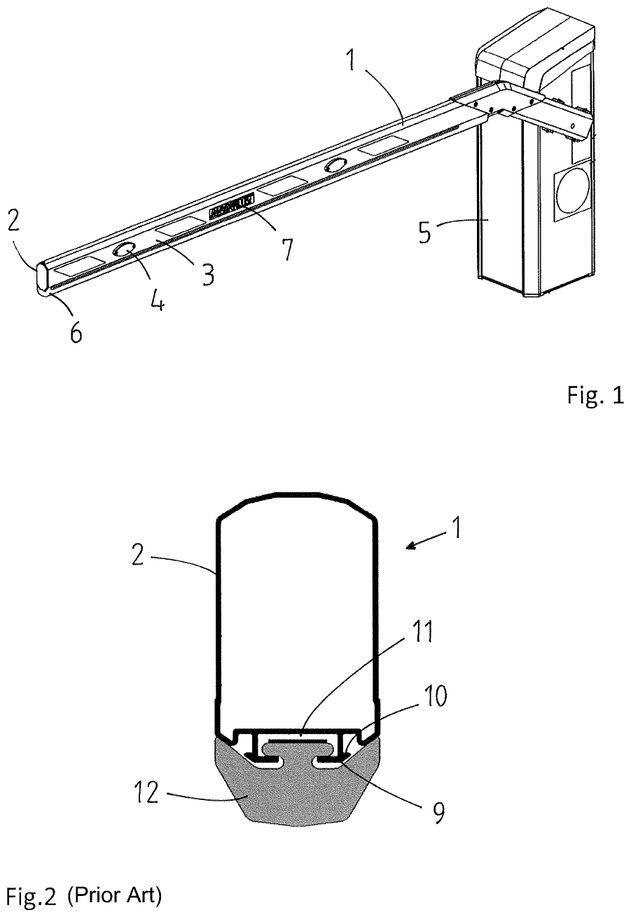

The boom gate for passage control of vehicles which is shown in a schematic view in FIG. 1 comprises a boom arm 1 having an arm profile 2, which, provided with films 3 and reflectors 4, forms the essential part of the boom arm 1, as well as a boom housing 5, on which the boom arm 1 is pivotably mounted and which contains the drive (not visible) for the boom arm 1.

The boom arm 1 shown in FIG. 1 is equipped according to the invention with a light signal, because of which a carrier rail 6 is arranged on the lower side of the boom arm 1. A light exit surface 7 of a light guide 8 (otherwise not recognizable here) can be seen between the carrier rail 6 and arm profile 2, arranged laterally on the boom arm 1 in its lower area. This light signal is also located on the rear side (not visible here) of the boom arm 1.

Due to the very narrow light exit surface 7, the light signal is very well visible on both sides of the boom arm 1, thus upon approaching it from the front and from the rear, but not from above and from below, which becomes important if the boom arm 1 is located in its open position. A blinding effect in particular in the open position of the boom arm 1 is therefore precluded. At the same time, the narrow light exit surface 7 on the boom arm 1 is unambiguously arranged in its lower area, which is recognizable at first glance even if the boom arm 1 is in its open position and is thus perceived; the risk of confusion in the case of multiple boom gates arranged adjacent to one another is minimized in this way.

The light exit surface 7 can be used solely to illuminate the boom arm 1 in poor light conditions and in particular at night in order to make it visible. However, it can preferably also be used for signaling purposes, for example, in that a red light indicates that passage is not possible and a green light signals an entry possible with corresponding authorization and the like, for example, also using flashing characters and/or chaser lights.

FIG. 2 shows a section through a boom arm 1 as can also be used in the prior art in a boom gate from FIG. 1. This boom arm 1 is designed according to the prior art. The arm profile 2 of this boom arm 1 consists of an aluminum extruded profile, which is equipped on its lower side with profile rails 9, with undercuts 10 created thereby, and with a mounting groove 11. A soft-elastic edge protector 12 is pushed into the mounting groove 11, which is seated in a formfitting manner in the arm profile 2 due to the undercuts 10.

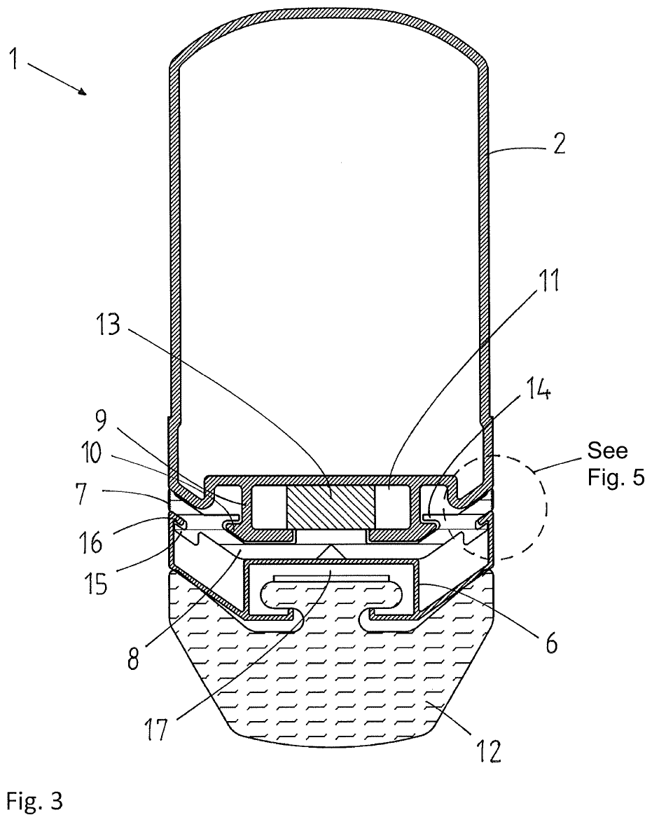

FIG. 3 shows, in a corresponding illustration to FIG. 2, the refinement according to the invention of the boom arm 1 from FIG. 2: The arm profile 2 as such is designed identically to that in the example from the prior art shown in FIG. 2, i.e. the mounting groove 11, the profile rails 9, and the undercuts 10 are still present on its lower side.

According to the invention, a light-emitting strip 13 is now pushed in a formfitting manner into the mounting groove 11, which emits light downward from the mounting groove 11 and couples it into the light guide 8.

The light guide 8 is shaped approximately V-shaped in its profile and consists of a profiled molded part having first rail elements 14, which engage behind the undercuts 10 of the profile rails 9 of the arm profile 2 and thus enable the light guide 8 to be pushed longitudinally into the profile rails 9 of the arm profile 2 for a formfitting connection.

On its lower side, the light guide 8 is provided with second rail elements 15, which in turn form undercuts in order to accommodate bends 16, which are hooked in profile, of the carrier rail 6 in a formfitting manner. The carrier rail 6 can thus likewise be pushed in a formfitting manner longitudinally into the second rail elements 15 of the light guide 8, so that a stable connection results between the arm profile 2, the light guide 8, and the carrier rail 6, without having to provide additional mounting means.

The carrier rail 6 likewise consists of an aluminum extruded profile, and its profile is designed so that it corresponds to the profile of the lower side of the arm profile 2, in particular having a carrier rail mounting groove 17. The edge protector 12, which is designed identically to that in the prior art according to FIG. 2, is pushed in a formfitting manner into this carrier rail mounting groove 17 in the same way as in the arm profile 2 according to the prior art (FIG. 2), i.e. from the viewpoint of the edge protector 12, nothing has changed due to the design according to the invention having light-emitting strip 13, light guide 8, and carrier rail 6.

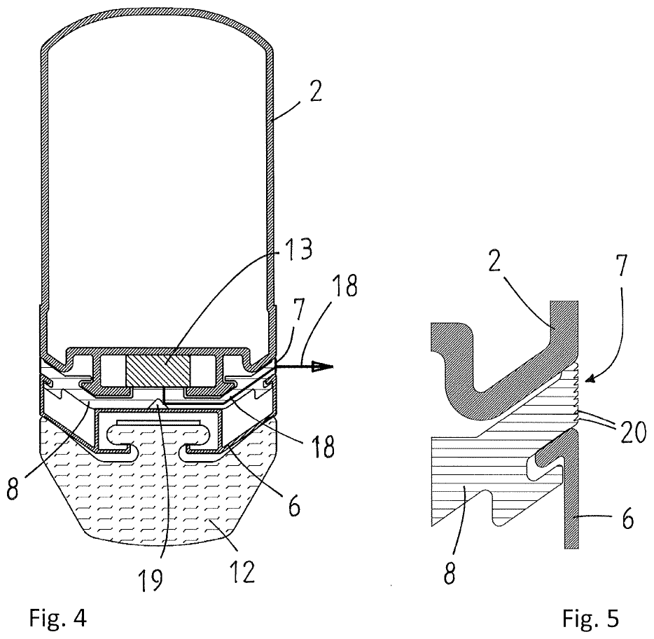

As is clear in particular from FIG. 4, which shows the lower section of the arm profile 2 from FIG. 3, light, which is symbolized by a light beam 18, is emitted downward from the light-emitting strip 13 and coupled into the light guide 8, where a prismatic boundary surface 19 ensures a deflection of the light beam 18 to the side. The light beam 18 is then conducted inside the light guide 8 to the light exit surface 7, where it exits to the outside, preferably in horizontal orientation. The carrier rail 6 covers the light guide 8 on the bottom, so that the light of the light-emitting strip 13 is actually only perceptible at the light exit surfaces 7.

FIG. 5 shows detail A from FIG. 3 in an enlargement to illustrate that the light exit surface 7 is provided with an array of prismatic depressions 20 extending along the arm profile 2, in order to scatter the light beam 18 at the light exit surface 7 and in this way improve the perceptibility of the light signal.

### LIST OF REFERENCE SIGNS

1 boom arm
2 arm profile
3 films
4 reflector
5 boom housing
6 carrier rail
7 light exit surface
8 light guide
9 profile rails
10 undercuts
11 mounting groove
12 edge protector
13 light-emitting strip
14 rail elements (first)
15 rail elements (second)
16 bends
17 carrier rail mounting groove
18 light beam
19 boundary surface
20 prismatic depressions

1. A boom arm (1) for a boom gate, the boom arm comprising:
an arm profile (2), which forms an essential part of the boom arm (1),
a light-emitting strip (13) attached over at least a part of a length of the arm profile (2) on a lower side thereof that is adapted to emit visible light into surroundings of the boom arm (1),
wherein the light-emitting strip (13) emits light over an entire length thereof or at multiple points distributed over the entire length,
the light-emitting strip (13) is combined with a light guide (8), into which the light emitting strip radiates the light,
the light guide (8) is fastened to the arm profile (2) from below,
and a carrier rail (6) for add-on parts located below the light guide (8), attached to the light guide (8) and/or to the arm profile (2).

2. The boom arm as claimed in claim 1, further comprising
a mounting groove (11) on the lower side of the arm profile (2) in which the light emitting strip (13) is seated.

3. The boom arm as claimed in claim 1,
wherein the light guide (8) is in a formfitting manner into the arm profile (2).

4. The boom arm as claimed in claim 3,
wherein the light guide (8) has a profile having undercuts (10) and the carrier rail (6) is inserted in a formfitting manner into the undercuts (10) of the light guide (8).

5. The boom arm as claimed in claim 4,
wherein the carrier rail (6) is insertable in a formfitting manner into the arm profile (2).

6. The boom arm as claimed in claim 2,
wherein the carrier rail (6) has on a lower side thereof a carrier rail mounting groove (17) formed essentially identically to the mounting groove (11) of the arm profile (2).

7. The boom arm as claimed in claim 1 6,
wherein the carrier rail (6) covers the light guide (8) on the bottom, such that the light guide (8) only forms an externally visible light exit surface (7) laterally on the boom arm (1).

8. The boom arm as claimed in claim 7,
wherein the light exit surface (7) comprises a matte surface for light scattering.

9. The boom arm as claimed in claim 7,
wherein the light exit surface (7) comprises prismatic depressions (20) extending along the arm profile (2).

10. The boom arm as claimed in claim 7,
wherein the light-emitting strip (13) is fastened approximately in a middle on the lower side of the arm profile (2), and the light guide (8) below the light-emitting strip (13) has a prismatic boundary surface (19) for deflecting the light toward both sides of the boom arm (1).

11. The boom arm as claimed in claim 7,
wherein the light guide (8) has a V-shaped profile in order to conduct the light upward by V legs of the V-shaped profile, such that the light exit surfaces (7) are located at a height of or above the light-emitting strip (13).

12. The boom arm as claimed in claim 6, wherein the lower side of the carrier rail has essentially a same lower-side profile as the lower side of the arm profile (2).

13. The boom arm as claimed in claim 7, wherein the externally visible light exit surface (7) comprises two of the externally visible light exit surfaces located laterally on both sides of the boom arm (1).

14. The boom arm (1) of claim 1, wherein the boom gate is for a passage control of vehicles.
